(19) United States
(12) Patent Application Publication
(10) Pub. No.: US 2022/0067681 A1
(43) Pub. Date: Mar. 3, 2022

(54) AUTHOR VERIFYING APPARATUS / METHOD USING DECENTRALIZED NETWORK AND SELF-SOVEREIGN ID

(71) Applicants: Hwoa In CHOI, Seoul (KR); Yoon Il CHOI, Gyeonggi-do (KR)

(72) Inventors: Hwoa In CHOI, Seoul (KR); Yoon Il CHOI, Gyeonggi-do (KR)

(21) Appl. No.: 17/406,835

(22) Filed: Aug. 19, 2021

(30) Foreign Application Priority Data
Aug. 27, 2020 (KR) 10-2020-0108257

(51) Int. Cl. G06Q 20/12; G06Q 20/38; G06Q 20/40

(52) U.S. Cl. CPC G06Q 20/1235; G06Q 20/3827; G06Q 2220/00; G06Q 20/3821; G06Q 20/4014; G06Q 20/389

(57) ABSTRACT

Provided is an author verifying apparatus and method which can receive contests stored online or offline by a user, and register a verifiable credential in a decentralized network, the verifiable credential including metadata having information on at least a part of the attribute and hash value of the contents, at least some of the contents, and the DID of the user. Thus, the author verifying apparatus and method can objectively verify the creator of contents stored online or offline without an error, regardless of an environment such as the place in which the contents are stored.

### BACKGROUND

### 1. Technical Field

The present disclosure relates to verification, and more particularly, to an apparatus and method for verifying or confirming who is the true creator of contents.

### 2. Related Art

Modern people who live in the era of the Fourth Industrial Revolution write and post a lot of contents on websites such as SNS (Social Network Services), blogs and YouTube and share the contents, the SNS including FaceBook, Twitter, Naver Band and the like. For example, the contents include a text-type post in which the opinion of the corresponding writer is summarized, a picture created by the corresponding creator, a photograph or video taken by the corresponding creator and the like.

However, it is difficult to objectively confirm who is the creator of each of such huge contents. During a member joining process, an SNS or the like requests only some pieces of simple information (e.g. email address and the like) from a user who wants to be a member, without requesting sensitive personal information such as a resident registration number. Thus, it is not easy to accurately specify or confirm the identity of a user who has posted the corresponding contents on the SNS or the like.

Furthermore, when a user posted contents on his/her SNS a long time ago but removed the contents, it is not easy to prove that the user has posted the corresponding contents on his/her SNS. As described above, it is more difficult to objectively prove that the person who posted the contents is the user.

Furthermore, when a users did not post contents, created offline through his/her computer, on the SNS or the like but stored the contents only in his/her personal computer, such contents have been owned only by the user who created the contents. Thus, it is difficult to objectively prove when the contents were created by the user as the true creator of the contents, to such a level that a third party can trust the fact that the contents were created by the user.

### RELATED ART DOCUMENT

### Patent Document

(Patent Document 1) None

### Non-Patent Document

(Non-Patent Document 1) None

### SUMMARY

Various embodiments are directed to an authority verifying apparatus and method which can objectively verify the creator of contents stored online or offline without an error, regardless of an environment such as the place in which the contents are stored.

In an embodiment, an author verifying apparatus may include: a contents receiving unit configured to receive contents stored online or offline by a user; and a decentralized network registration unit configured to register a verifiable credential in a decentralized network, the verifiable credential including metadata having information on at least a part of the attribute and hash value of the contents, at least a part of the contents, and an DID (Decentralized ID) of the user.

The contents receiving unit may automatically receive contents in real time immediately after the contents are posted online by the user. At this time, the author verifying apparatus may communicate with a server on which the contents of the user are posted, and the server may push and transfer contents of the user to the contents receiving unit, whenever the contents of the user are posted.

The author verifying apparatus may communicate with a user-side computer having contents stored offline by the user. The contents receiving unit may receive the contents stored offline from the user-side computer, when connected to the user-side computer.

The decentralized network registration unit may register the verifiable credential in the decentralized network, and the ID of the user, which is used to log in the server on which the contents are posed, and the DID of the user may be matched with each other and included in the verifiable credential.

The decentralized network may be a public blockchain network.

The author verifying apparatus may further include a standardization unit configured to standardize information on the attribute of the contents, contained in the metadata of the contents received by the contents receiving unit.

The metadata which the decentralized network registration unit registers in the decentralized network may include information related to the standardized attribute.

The author verifying apparatus may further include: a search unit configured to search the decentralized network for at least a part of contents and metadata corresponding to contents to be verified and the DID of the user, matched with the contents and the metadata; and an identity information providing unit configured to provide the search result as the verifiable credential for the contents to be verified. In this case, the author verifying apparatus may further include a verification unit configured to verify that the DID in the verifiable credential received from the identity information providing unit corresponds to a creator of the contents to be verified. At this time, a verifiable credential including at least a part of the contents and the metadata of the contents and the DID of the user, which is matched with the contents and the metadata, may include an NFT (Non-Fungible Token)-type verifiable credential

When the contents were sold to another person different from the user or sold from the another person, the decentralized network registration unit updates the verifiable credential of the user by reflecting information on the sale. At this time, the information on the sale may include at least some of information on the assignment of an author's property right to the contents or a permission to use the contents, information on the price for sale, and information on the permission to use the contents.

In an embodiment, an author verifying method may include: receiving contents stored online or offline by a user; and registering a verifiable credential in a decentralized network, the verifiable credential including at least a part of the contents and metadata having information on at least a part of the attribute and hash value of the contents and an DID of the user.

The receiving of the contents may include automatically receiving contents in real time immediately after the contents are posted online by the user.

The receiving of the contents may include: connecting an apparatus, by which the author authorization method is performed, to a user-side computer having contents stored offline by the user; and receiving the contents stored offline by the user from the user-side computer.

The registering of the verifiable credential may include registering the verifiable credential in the decentralized network, wherein the ID of the user, which is used to log in the server on which the contents are posed, and the DID of the user are matched with each other and included in the verifiable credential.

The author verifying method may further include standardizing information on the attribute of the contents, contained in the metadata of the contents received by the contents receiving unit. The metadata which is registered in the decentralized network in the registering of the verifiable credential may include the standardized information on the attribute.

The author verifying method may further include: searching the decentralized network for at least a part of contents and metadata corresponding to contents to be verified and the DID of the user, matched with the contents and the metadata; and providing the search result as the verifiable credential for the contents to be verified. In this case, the author verifying method may further include verifying that the DID in the verifiable credential received in the providing of the search result corresponds to a creator of the contents to be verified.

When the contents were sold to another person different from the user or sold from the another person, the registering of the verifiable credential may include updating the verifiable credential of the user by reflecting information on the sale. The information on the sale may include at least some of information on the assignment of an author's property right to the contents or a permission to use the contents, information on the price for sale, and information on the permission to use the contents.

In an embodiment, there is provided a computer readable recording medium configured to store a computer program for executing, through a computer, an author verifying method may include: receiving contents stored online or offline by a user; and registering a verifiable credential in a decentralized network, the verifiable credential including at least a part of the contents and metadata having information on at least a part of the attribute and hash value of the contents and an DID of the user.

In accordance with the embodiments of the present disclosure, the author verifying apparatus and method can objectively verify the creator of contents stored online or offline without an error, regardless of an environment such as the place in which the contents are stored.

### BRIEF DESCRIPTION OF THE DRAWINGS

FIGS. 1A, 1B and 1C are reference diagrams for describing an author verifying system in accordance with at least an embodiment of the present disclosure.

FIG. 1D is a block diagram for describing an author verifying apparatus in accordance with at least the embodiment of the present disclosure.

FIG. 2 is a flowchart for describing an author verifying method which is performed by the author verifying apparatus in accordance with at least the embodiment of the present disclosure.

### DETAILED DESCRIPTION

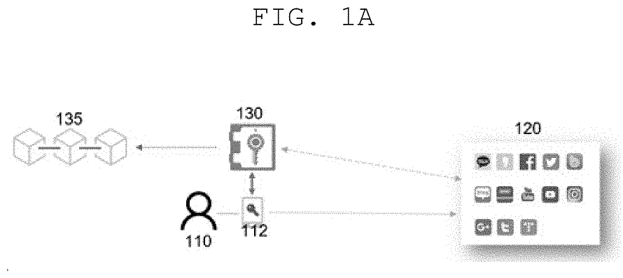

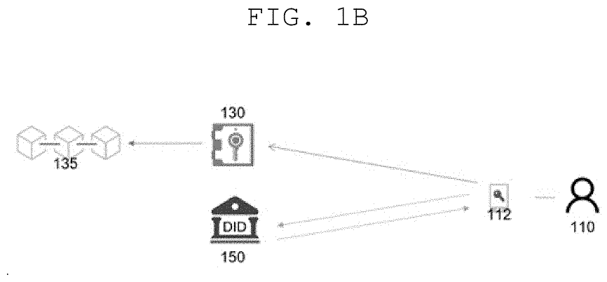

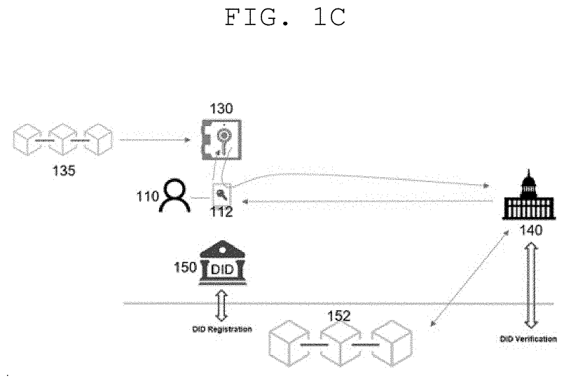

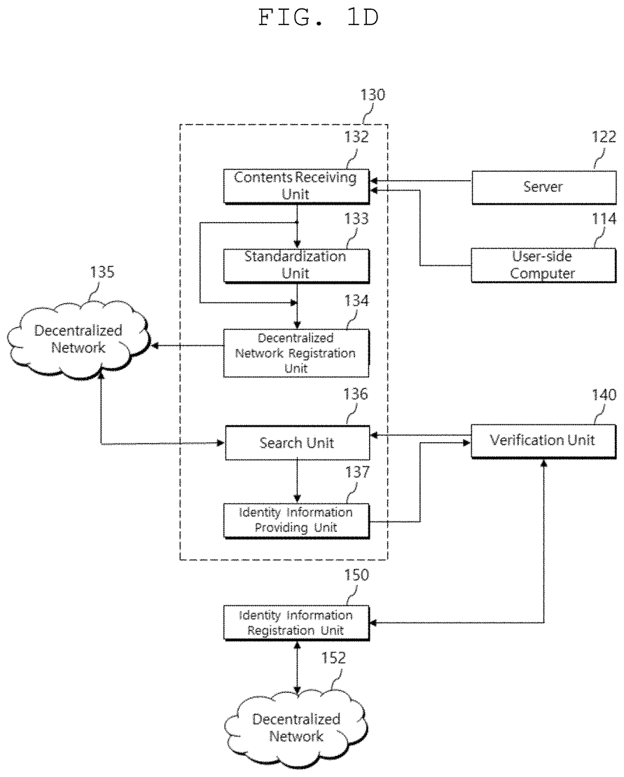

Referring to FIGS. 1A to 1D, an author verifying system and an author verifying apparatus in accordance with at least an embodiment of the present disclosure will be described as follows.

In this specification, contents indicate ‘information or contents that can be recognized by a person’. Examples of the contents may include \textcircled{1} a text-type post, \textcircled{2} a still image such as a picture or photograph, and \textcircled{3} a video. According to Article 2, Section 1 of the Copyright Law, the term ‘work’ indicates ‘a creative production that expresses human thoughts or emotions’. Contents may be ‘a work’ which is protected as a creative expression thing by the Copyright Law, or only a simple idea that expresses the thoughts or emotions of a subject (e.g. AI (Artificial Intelligence) or animal) which is not a human being. In some cases, contents may not be a work, because the contents have no creativity.

For convenience of description, this specification is based on the assumption that contents indicate contents which are created by a user in person, but the present disclosure is not limited thereto.

Furthermore, a verifiable credential including the contents, at least a part of the metadata of the contents, and the DID (Decentralized ID) of the user, which is matched with the contents and the metadata, include an NFT (Non-Fungible Token)-type verifiable credential. NFT refers to tradable data which is obtained by tokenizing digital contents, actual assets or the like, and registered on a blockchain network to guarantee the integrity of the contents thereof. In this specification, an embodiment of the configuration in which a verifiable credential including contents, at least a part of the metadata of the contents, and the DID of the user, which is matched with the contents and the metadata, is stored in a blockchain network includes an NFT-type verifiable credential.

In this specification, ‘author verifying apparatus’ or ‘author verifying system’ refers to an apparatus or system that verifies who is the creator of contents when a person asserts that he/she is the creator of the contents. If the contents are a work, the Copyright Law defines that the creator is ‘the author’. At this time, although the term ‘author’ is used, at least the embodiment of the present disclosure may be applied to not only ‘the case in which contents is a work’, but also ‘the case in which contents is not a work’.

Now, the author verifying system and the author verifying apparatus will be described with reference to FIGS. 1A to 1D.

A user 110 may indicate all persons who can create or post (store) contents. The user 110 may store his/her contents online or offline.

First, the case in which the user 110 stores contents online will be described with a specific example. The user 110 may log in a website 120 using his/her smart phone 112 or PC (Personal Computer) and post contents, the website 120 including \textcircled{1} SNS such as Twitter, FaceBook or Instagram, \textcircled{2} a blog or cafe, and \textcircled{3} YouTube. As such, the user may post contents such that many people can share the contents under an Internet environment. When the user posts contents on the SNS or the like, it indicates that the user store the corresponding contents in a server 122 of the SNS or the like.

On the other hand, the user 110 may store contents offline. For example, the user 110 may work on a document on his/her PC (hereafter, referred to as ‘a user-side computer 114’) while communicating with nobody under the environment where the Internet is not provided.

In this specification, ‘author verifying system’ collectively indicates systems illustrated in FIGS. 1A to 1C, and an author verifying apparatus 130′ is an apparatus that constitutes a part of the author verifying system and provides a notary service. In accordance with an embodiment of the present disclosure, a user who wants to use the author verifying apparatus 130 needs to become a member of the author verifying apparatus 130. Thus, each user who wants to use an author verifying technology in accordance with at least the embodiment of the present disclosure requires an ID (hereafter, referred to as ‘verification service ID’) for logging in the author verifying apparatus 130. However, this is only an example, and the author verifying apparatus 130 may be operated so as to be open to members only or open to anonymous users.

As illustrated in FIG. 1D, the author verifying apparatus 130 may include a contents receiving unit 132, a standardization unit 133, a decentralized network registration unit 134, a search unit 136 and an identity information providing unit 137.

Among the components of the author verifying apparatus 130, the contents receiving unit 132, the standardization unit 133 and the decentralized network registration unit 134 will be first described. All of the three components are components which perform preparation operations required for performing author verification in accordance with at least the embodiment of the present disclosure.

The contents receiving unit 132 receives contents stored online or offline by the user 110. Contents that the user 110 posts on the website 120 such as SNS, i.e. the server 122 of the SNS, are an example of the contents stored online by the user, and contents that the user stores in a user-side computer 114 under the environment where the Internet communication is not provided is an example of the contents stored offline by the user.

The contents receiving unit 132 may automatically receive the contents posted online by the user 110 in real time immediately after the contents are posted. For this operation, the author verifying apparatus 130 communicates with the server 122 on which the contents of the user are posted, and the server 122 transfers the contents of the user 110 to the contents receiving unit 132, whenever the contents of the user 110 are posted.

A specific example thereof will be described as follows. The user has matched an ID, which is used to log in the SNS or the like and hereafter referred to as ‘SNS ID’, with a verification service ID (for example, the user might have matched his/her verification service ID with his/her friends in the SNS). Whenever contents are posted, the SNS or the like transfers the contents to his/her friends through a push function. In accordance with at least the embodiment of the present disclosure, the author verifying apparatus 130 may automatically collect the contents of the user, even though a separate program is not installed in the author verifying apparatus 130.

The contents receiving unit 132 may receive the contents stored ‘offline’ by the user 110. Specifically, the author verifying apparatus 130 may communicate with the user-side computer of the user 110, and the contents receiving unit 132 may receive the contents stored offline from the user-side computer 114, when connected to the user-side computer 114.

As such, the contents that the contents receiving unit 132 receives from the server 122 of the SNS or the like or the user-side computer 114 are computer-processable contents, and may be configured as message-type contents in the form of xml or json or configured as file-type contents.

The received contents may include ‘metadata’ which contains information on the attribute of the contents. However, the metadata in the contents transmitted by the server 122 of the SNS or the like may be configured in a different format for each SNS or the like. The attribute contained in the metadata can be recognized by a person, and may include several entries such as the creation date, the creation time and the file size. For each SNS, information on some entries contained in the metadata, among the entries, and the order and configuration of the entries may be different.

For this reason, the standardization unit 133 may be needed. Whenever the contents receiving unit 132 receives contents, the standardization unit 133 standardizes information on the attributes of the contents, contained in the metadata of the contents, into a predetermined format. However, the standardization unit 133 is a component which may be omitted from the author verifying apparatus 130, and such a standardization operation is not a necessary operation.

The decentralized network registration unit 134 may create ‘a verifiable credential’, and register the verifiable credential in a decentralized network 135. The verifiable credential may include \textcircled{1} ‘metadata having information on at least a part of the hash value and attribute of the contents (which might have been passed through the standardization unit 133 or not) received from the server 122 of the SNS or the like or the user-side computer 114 by the contents receiving unit 132’ and at least some of ‘the contents themselves’, and \textcircled{2} ‘the DID of the user’. At this time, an embodiment of the verifiable credential includes an NFT-type verifiable credential.

The hash value may refer to information such as the fingerprint of the contents, and the author verifying apparatus 130 may insert information, through which the creator of the contents can be objectively identified, as the hash value into the metadata of the contents. For example, the author verifying apparatus 130 may insert the hash value of the contents, which the user having created the contents signed on the basis of his/her DID, into the metadata of the contents. The metadata of the contents processed by the decentralized network registration unit 134 may include not only the information on the attributes of the contents but also the hash value of the contents.

The decentralized network registration unit 134 may register the metadata of the contents in the decentralized network 135 such as a blockchain network, but register the contents themselves.

In the case of a blockchain network, when a new block is intended to be added and connected to the existing blockchain network, all nodes connected to the blockchain network must agree with the ledger contents of the new block, and agree with the addition and connection of the new block. In the current blockchain networks, the time required for reaching the agreement, i.e. a block time, is considerably long. Averagely, Bitcoin requires a block time of 10 minutes, and Ethereum requires a block time of 15 seconds. In the current situation, the storage capacity of a blockchain node is typically smaller than that of a PC or the like.

However, since ‘contents’ (specifically, contents such as video contents, whose volume is considerably large) themselves have a larger volume than ‘meta data of contents’, it may be difficult to store the contents in a blockchain node, even though the user desires to register the contents in the blockchain node. Although the contents are stored in the blockchain node, the block time may be increased. Therefore, in accordance with at least the embodiment of the present disclosure, the decentralized network registration unit 134 registers ‘the metadata of the contents’ in the decentralized network 135, instead of ‘the contents’ themselves. Even for contents of a user who are reluctant to register and publish the contents in the decentralized network, the decentralized network registration unit 134 may register ‘the metadata of the contents’ in the decentralized network 135, instead of ‘the contents’ themselves.

On the other hand, if the blockchain technology further develops, the storage capacity of a blockchain node may be increased, and the average block time may be shortened more than in the current blockchain networks. In this case, when a user wants to publish the contents received by the contents receiving unit 132, the decentralized network registration unit 134 may register the contents in the decentralized network 135. These cases are only examples.

The decentralized network registration unit 134 may register only the metadata in the decentralized network 135, register the contents themselves in the decentralized network 135, and register both the contents themselves and the metadata thereof in the decentralized network 135.

When registering at least some of the contents themselves and the metadata thereof in the decentralized network, the decentralized network registration unit 134 may register the contents and metadata with the DID of the corresponding user. The DID is not a verification means such as an authentication certificate or residence registration card, which is managed by a central organization, but a decentralized identity verification means which is self-owned and managed, and is also referred to as ‘mobile ID’ or ‘self sovereign ID’.

In connection with ‘the verifiable credential’, the contents of this paragraph will be described as follows. The decentralized network registration unit 134 in accordance with at least the embodiment of the present disclosure generates ‘the verifiable credential’ for ‘each contents of the user’ and registers the generated verifiable credential in the decentralized network. In this specification, ‘the verifiable credential’ indicates ‘credential data’ such as ‘ID’ which can be used in the decentralized network. The verifiable credential′ generated and registered by the decentralized network registration unit 134 may include \textcircled{1} ‘at least some of contents themselves and the metadata of the contents’ and \textcircled{2} the DID of the corresponding user. In an embodiment, the verifiable credential includes NFT-type verifiable credential.

In connection with \textcircled{2}, the decentralized network registration unit 134 may generate a verifiable credential containing “the ID of the user 110, which is used to log in the server 122 on which the contents are posted, i.e. ‘the SNS ID’”, “the verification service ID (when the author verifying apparatus 130 is operated so as to be open to members only)”, and “the DID of the user” while matching the IDs with one another, and register the generated verifiable credential in the decentralized network. More specifically, the server 122 of the SNS or the like may generate a verifiable claim containing information ‘verifying who is the creator of the corresponding contents’ i.e. the SNS ID, and provide the generated variable claim to the decentralized network registration unit 134, and the decentralized network registration unit 134 may generate and register a verifiable credential for the contents, by using the verifiable claim received from the server 122 of the SNS or the like. The verifiable claim will constitute a part of the verifiable credential generated and registered by the decentralized network registration unit, and needs to be distinguished from the verifiable credential.

The decentralized network 135 serving as the space in which the decentralized network registration unit 134 registers a verifiable credential for each user and contents may be a private blockchain network, a public blockchain network or any other decentralized network. The private blockchain network is a closed blockchain network, but the public blockchain network is an open blockchain network such as Bitcoin or Ethereum, which anyone can access. The blockchain network which is more appropriate to a DID whose principle needs to be transparent and which can be internationally used may be the public blockchain network.

The author verifying apparatus in accordance with at least the embodiment of the present disclosure is an apparatus for verifying or authorizing who is the creator of certain contents, as objectively as possible, and a verification or authorization operation which is performed when contents to be verified are given will be described below in detail, and the above-described operation is a preparation operation which is required for performing the verification or authentication operation.

The search unit 136 searches for ‘at least some of contents and metadata thereof’ corresponding to ‘the contents to be verified’, among at least some of the contents registered in the decentralized network 135 and metadata corresponding to the respective contents, and ‘the DID of a user’, matched with the contents and the metadata thereof. Here, ‘the contents to be verified’ indicate certain contents in a lawsuit to decide who is the author of the contents. For example, a plaintiff may assert that “a defendant has infringed the copyright of contents (work) A, created by the plaintiff, by illegally coping the contents”, in a lawsuit in which the plaintiff lodged a compensation claim against the defendant for the copyright infringement. In this case, in order to determine whether the plaintiff is the creator (author) of the contents A, the author verifying apparatus 130 in accordance with at least the embodiment of the present disclosure may objectively verify who is the creator of the contents A, according to an order of the court. Here, the contents A are very ‘the contents to be verified’.

The subject who provides the search unit 136 with ‘the contents to be verified’ is the verification unit 140. In the above-described example, a server of the court corresponds to the verification unit 140.

The search result of the search unit 136 is ‘at least some of the contents and the metadata thereof’, which correspond to ‘the contents to be verified’, and ‘the DID of the user’, matched with the contents and the metadata, and the identity information providing unit 137 provides the verification unit 140 with the search result as ‘a verifiable credential for the contents to be verified’.

The verification unit 140 may verify that the DID in ‘the verifiable credential’ received from the identity information providing unit 137 is very the creator (author) of the corresponding contents. For this operation, a person who wants to use the author verifying apparatus 130 needs to have his/her own ‘DID’ in advance. Furthermore, in order to prove that the person is the owner of the DID, the person needs to have a public key and a private key. The public key is a key which is generated through the private key and opened to everyone, but the private key must not be opened to any one but be owned only by the corresponding person. The verification unit 140 may accurately verify who is the creator of the corresponding contents, through verification based on the public key, as objectively as possible.

For convenience of description, FIG. 1D illustrates that the verification unit 140 is located outside the author verifying apparatus 130. The present disclosure is not limited thereto, but the verification unit 140 may be located inside the author verifying apparatus 130.

An identity information registration unit 150 registers the DIDs of all users and the public keys for the respective DIDs in a decentralized network 152 such as a blockchain network, and manages the DIDs and the public keys. When the verification unit 140 intends to check whether a certain user A is the owner of a searched DID, the verification unit 140 may receive the public key of the DID from the user A through the identity information registration unit 150, and use the received public key to perform the check operation, as described above.

The decentralized network 152 in which the identity information registration unit 150 registers the DID and the like may be a public blockchain network like the above-described decentralized network 135, a private blockchain network or other decentralized networks. The decentralized network 152 may be the same as or different from the decentralized network 135.

For reference, the private key for the DID is not managed by the identity information registration unit 150. Unlike the public key, the private key may be stored in a private storage by the identity information providing unit 137 of the author verifying apparatus 130 which provides a custody service, and managed by the identity information providing unit 137. From the point of view that the DID is self-owned and managed, a separate organization which holds the DID may not exist in the form of the identity information providing unit 137. However, even in the future where the blockchain system will be further popularized, an organization corresponding to the identity information providing unit 137 which manages private keys as described above will seem to be necessary. The private key needs to be frequently backed up in order to prepare for the case in which the owner thereof accidently loses the private key. Once the private key is lost, the private key cannot be restored forever. Thus, it is realistically impossible for each person to thoroughly manage the private key.

So far, the method in which the author verifying apparatus in accordance with at least the embodiment of the present disclosure objectively checks and verifies the creator of contents has been described. As will be described below, however, the author verifying apparatus in accordance with at least the embodiment of the present disclosure may also confirm or verify a right holder from a subsequent trade of contents as well as the creator of the contents.

In order to promote understandings of this process, it is necessary to introduce general legal principles about the assignment of an author's property right.

As described above, contents may be a work or not. For convenience of description, the following descriptions will be based on the assumption that contents are a work.

As soon as a creator creates contents, the copyright of the contents belongs to the creator. The copyright includes ‘an author's property right’ as a property right and ‘an author's moral right’ as a moral right. Between the rights, the author's property right can be assigned to another person, but the author's moral right cannot be assigned to another person, because the author's moral right is an inalienable right.

For example, a person X created contents A and then sold the contents to another person Y. The right that the person Y has for the contents A in this case will be described. When the person X sells a material being (e.g. CD) containing the contents A to the person Y, the relationship of rights from the sale corresponds to any one of the following two cases.

The first case is where the person X still has an author's property right to the contents A, and permits the person Y only to use the contents. Thus, the person X as an author of the contents A has both of the author's property right and the author's moral right to the contents A. In this case, the person Y does not have an author's property right to the contents A, but has only a right to use the contents A. In such a situation, whether the person Y infringes the author's property right of the person X depends on whether the person Y uses the contents A while observing a condition and range about the permission to use the contents A.

The second case is where the person X has only the author's moral right, and assigns the author's property right to the contents A to the person Y. In this case, the person having the author's property right to the contents A is not the person X but the person Y. In general, the person Y will prefer the second case to the first case, but the price for sale in the second case (i.e. the price for the assignment of the author's property right) is higher than the price for sale in the first case (i.e. a usage price which needs to be paid to get a permission to use the contents). Thus, the interests of several parties may be sharply opposed surrounding the sale of the contents.

The author verifying apparatus in accordance with at least the embodiment of the present disclosure may not only verify or authorize who is the creator of contents, which is assumed to be a work for convenience of description, but also verify or authorize who is the subsequent right holder from the sale of the contents.

For this operation, when generating a verifiable credential for each contents of a user X, the above-described decentralized network registration unit 134 may update the verifiable credential of the user X for the contents by reflecting information on the sale of the contents, in case that ‘the contents were sold to a person different from the user X or sold from a person different from the user X’. Here, ‘the information on the sale’ may include the information on the assignment of the author's property right to the contents or the permission to use the contents, the price for sale, and at least a part of the information on the permission.

Thus, the above-described identity information providing unit 137 provides a verifiable credential indicating information on whether the corresponding contents are sold contents or information on the sale when the contents are sold contents, and the verification unit 140 may confirm or verify to whom the current author's property right to the contents belongs.

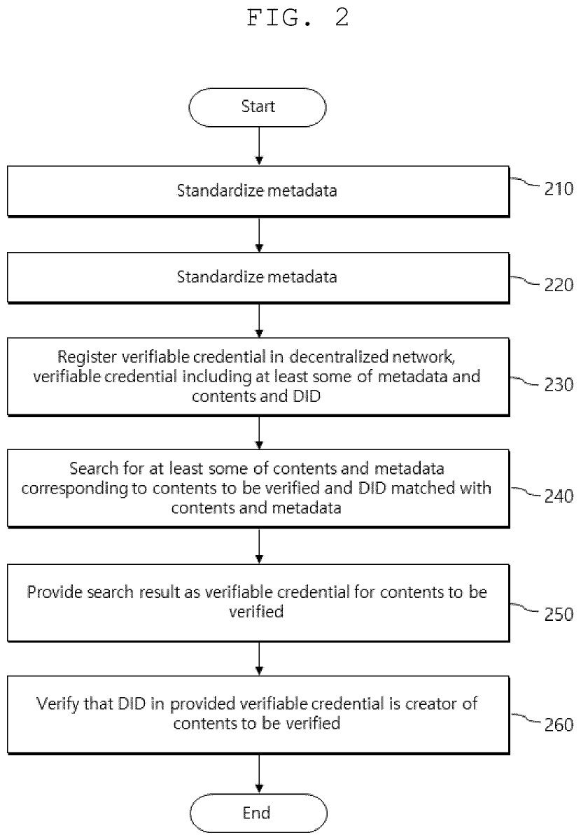

Next, an author verifying method will be described with reference to FIG. 2. The author verifying method of FIG. 2 will be organically described with reference to FIGS. 1A to 1D.

The contents receiving unit 132 receives contents stored online or offline by a user in step 210.

After step 210, the standardization unit 133 standardizes information on the attributes of the contents, contained in the metadata of the contents received in step 210, in step 220.

After step 220, the decentralized network registration unit 134 generates ‘a verifiable credential’ containing at least some of ‘metadata having information on at least a part of the attribute (whose format has been standardized in step 220) and hash value of the contents received in step 210’ and ‘the contents’ and ‘the DID of the user’, and registers the verifiable credential in the decentralized network, in step 230.

After step 230, the search unit 136 searches the decentralized network for at least some of the metadata and contents corresponding to the contents to be verified and the DID of the user, matched with the metadata and contents, in step 240.

After step 240, the identity information providing unit 137 provides the search result of step 240 as the verifiable credential for the contents to be verified, in step 250.

After step 250, the verification unit 140 verifies that the DID in the verifiable credential received in step S250 corresponds to the creator of the contents to be verified, in step 260.

A computer readable recording medium in accordance with at least an embodiment of the present disclosure may store a computer program for executing the author verifying method (see FIG. 2).

The foregoing description of the present disclosure is only for some embodiments, and the person skilled in the art to which the present disclosure pertains can carry out various modifications of the some embodiments without departing from the scope of the claims. Therefore, it should not be interpreted that the claims are limited to the some embodiments.

### INDUSTRIAL APPLICABILITY

The author verifying apparatus and method in accordance with at least the embodiment of the present disclosure may be used for an author verification or authorization industry.

1. An author verifying apparatus comprising:
a contents receiving unit configured to receive contents stored online or offline by a user; and
a decentralized network registration unit configured to register a verifiable credential in a decentralized network, the verifiable credential including metadata having information on at least a part of the attribute and hash value of the contents, at least a part of the contents, and an DID (Decentralized ID) of the user.

2. The author verifying apparatus of claim 1, wherein the contents receiving unit automatically receives contents in real time immediately after the contents are posted online by the user.

3. The author verifying apparatus of claim 2, wherein the author verifying apparatus communicates with a server on which the contents of the user are posted, and the server pushes and transfers contents of the user to the contents receiving unit, whenever the contents of the user are posted.

4. The author verifying apparatus of claim 1, wherein the author verifying apparatus is able to communicate with a user-side computer having contents stored offline by the user,
wherein the contents receiving unit receives the contents stored offline from the user-side computer, when connected to the user-side computer.

5. The author verifying apparatus of claim 1, wherein the decentralized network registration unit registers the verifiable credential in the decentralized network, wherein the ID of the user, which is used to log in the server on which the contents are posed, and the DID of the user are matched with each other and included in the verifiable credential.

6. The author verifying apparatus of claim 1, wherein the decentralized network is a public blockchain network.

7. The author verifying apparatus of claim 1, further comprising a standardization unit configured to standardize information on the attribute of the contents, contained in the metadata of the contents received by the contents receiving unit,
wherein the metadata which the decentralized network registration unit registers in the decentralized network includes information related to the standardized attribute.

8. The author verifying apparatus of claim 1, further comprising:
a search unit configured to search the decentralized network for at least a part of contents and metadata corresponding to contents to be verified and the DID of the user, matched with the contents and the metadata; and
an identity information providing unit configured to provide the search result as the verifiable credential for the contents to be verified.

9. The author verifying apparatus of claim 8, further comprising a verification unit configured to verify that the DID in the verifiable credential received from the identity information providing unit corresponds to a creator of the contents to be verified.

10. The author verifying apparatus of claim 1, wherein when the contents were sold to another person different from the user or sold from the another person, the decentralized network registration unit updates the verifiable credential of the user by reflecting information on the sale.

11. The author verifying apparatus of claim 10, wherein the information on the sale comprises at least some of information on the assignment of an author's property right to the contents or a permission to use the contents, information on the price for sale, and information on the permission to use the contents.

12. An author verifying method comprising:
receiving contents stored online or offline by a user; and
registering a verifiable credential in a decentralized network, the verifiable credential including at least a part of the contents and metadata having information on at least a part of the attribute and hash value of the contents and an DID (Decentralized ID) of the user.

13. The author verifying method of claim 12, wherein the receiving of the contents comprises automatically receiving contents in real time immediately after the contents are posted online by the user.

14. The author verifying method of claim 12, wherein the receiving of the contents comprises:
connecting an apparatus, by which the author authorization method is performed, to a user-side computer having contents stored offline by the user; and
receiving the contents stored offline by the user from the user-side computer.

15. The author verifying method of claim 12, wherein the registering of the verifiable credential comprises registering the verifiable credential in the decentralized network, wherein the ID of the user, which is used to log in the server on which the contents are posed, and the DID of the user are matched with each other and included in the verifiable credential.

16. The author verifying method of claim 12, wherein the decentralized network is a public blockchain network.

17. The author verifying method of claim 12, further comprising standardizing information on the attribute of the contents, contained in the metadata of the contents received by the contents receiving unit, wherein the metadata which is registered in the decentralized network in the registering of the verifiable credential includes the standardized information on the attribute.

18. The author verifying method of claim 12, further comprising:
searching the decentralized network for at least a part of contents and metadata corresponding to contents to be verified and the DID of the user, matched with the contents and the metadata; and
providing the search result as the verifiable credential for the contents to be verified.

19. The author verifying method of claim 18, further comprising verifying that the DID in the verifiable credential received in the providing of the search result corresponds to a creator of the contents to be verified.

20. The author verifying method of claim 12, wherein when the contents were sold to another person different from the user or sold from the another person, the registering of the verifiable credential comprises updating the verifiable credential of the user by reflecting information on the sale.

21. The author verifying method of claim 20, wherein the information on the sale comprises at least some of information on the assignment of an author's property right to the contents or a permission to use the contents, information on the price for sale, and information on the permission to use the contents.

22. A computer readable recording medium configured to store a computer program for executing the method of claim 12 in a computer.
